(19) United States
(12) Patent Application Publication
(10) Pub. No.: US 2012/0120209 A1
(43) Pub. Date: May 17, 2012

(54) DISPLAY DEVICE AND VIDEO VIEWING SYSTEM

(76) Inventors: Yoshio UMEDA, Hyogo (JP); Takahiro KOBAYASHI, Osaka (JP); Seiji HAMADA, Osaka (JP); Masaharu TSUJIMURA, Osaka (JP)

(21) Appl. No.: 13/355,920

(22) Filed: Jan. 23, 2012

Related U.S. Application Data
(63) Continuation of application No. PCT/JP2011/002987, filed on May 27, 2011.

(30) Foreign Application Priority Data
Jun. 8, 2010 (JP) 2010-131075

(51) Int. Cl. H04N 13/04

(52) U.S. Cl. 348/54; 348/E13.026

(57) ABSTRACT

A display device includes a liquid crystal panel which switches between a left frame image which is viewed by a left eye and a right frame image which is viewed by a right eye to alternately display the left and right frame images on a display surface with time; and a liquid crystal driver which scans and drives the liquid crystal panel with a frame image signal for displaying the left or right frame image over the display surface. The liquid crystal driver executes a first scanning operation over the display surface and a second scanning operation over the display surface after the first scanning operation, and the first scanning operation is executed in a shorter period than the second scanning operation.

### TECHNICAL FIELD

The present invention is related to a display device and a video viewing system which display stereoscopic images.

### BACKGROUND OF THE INVENTION

A display device alternately displays a left frame image, which is viewed by the left eye, and a right frame image, which is viewed by the right eye, at a predetermined cycle (e.g. field cycle) to create a stereoscopic image. The displayed left and right frame images are different in contents by a parallax amount. A viewer watches the left and right frame images through an eyeglass device, which includes liquid crystal shutters driven in synchronism with the display cycle of the left and right frame images (e.g. Patent Documents 1 and 2). As a result, the viewer may stereoscopically perceive an object rendered in the left and right frame images.

FIG. 12 is a block diagram showing a conventional video viewing system. A video signal at 60 Hz (left video signal and right video signal) is input in the video viewing system shown in FIG. 12.

The video viewing system 900 has a video signal processor 901 to which the video signal at 60 Hz (left and right video signals) are input. The video signal processor 901 converts the input video signal into a left video signal at 120 Hz and a right video signal at 120 Hz. The left and right video signals after the conversion are output to a liquid crystal driver 902 and a backlight controller 903. The liquid crystal driver 902 converts the left and right video signals at 120 Hz into a display format for a liquid crystal panel 904. The left and right video signals, which are converted by the liquid crystal driver 902, are output to the liquid crystal panel 904. The backlight controller 903 outputs an emission control signal to a backlight source 905. The backlight source 905 irradiates light onto the liquid crystal panel 904 from the rear surface of the liquid crystal panel 904 in response to the emission control signal, so that left and right frame images are alternately displayed on the liquid crystal panel 904 at 120 Hz.

An eyeglass device 950 has a left shutter 951 and a right shutter 952. A shutter control circuit 906 for the left shutter 951 and a shutter control circuit 907 for the right shutter 952 synchronously control the left and right shutters 951, 952 in response to the left and right video signals at 120 Hz converted by the video signal processor 901.

FIG. 13 is a control timing chart of the conventional video viewing system 900. The section (A) in FIG. 13 shows scanning timings of the left and right frame images on the liquid crystal panel 904. The section (B) in FIG. 13 shows lighting timings of the backlight source 905. Switching timings between the shutters 951, 952 of the eyeglass device 950 are shown in the section (C) of FIG. 13. The conventional video viewing system 900 is described with reference to FIGS. 12 and 13.

The left and right video signals are sequentially written to the liquid crystal panel 904. Meanwhile, the backlight source 905 is always ON. The shutter control circuits 906, 907 control the shutters 951, 952, respectively. After scanning the liquid crystal panel 904 by alternately writing the left and right video signals, the shutters 951, 952 are switched under the control of the shutter control circuits 906, 907, so that each shutter open period becomes half of each video period. The left and right frame images viewed through the shutters 951, 952 are perceived by the left and right eyes of the viewer, respectively, so that the viewer may visually generate a stereoscopic image in the brain.

In the video viewing system which operates at the control timings shown in FIG. 13, the viewer views the left or right frame image only while the shutter 951 or 952 is open (period long enough to view the images and generate the stereoscopic image). The backlight source 905, on the other hand, is always ON, even during periods other than while the shutter 951 or 952 is open. This means that the video viewing system, which operates at the control timings shown in FIG. 13, is not preferable in terms of conserving energy.

FIG. 14 is another control timing chart of the conventional video viewing system 900. The section (A) in FIG. 14 shows scanning timings of the left and right frame images on the liquid crystal panel 904. The section (B) in FIG. 14 shows lighting timings of the backlight source 905. Switching timings between the shutters 951, 952 of the eyeglass device 950 are shown in the section (C) of FIG. 14. The conventional video viewing system 900 is described with reference to FIGS. 12 to 14.

Patent Document 2 discloses a control for the backlight source 905 to turn ON only while the left or right frame image is viewed. In the case of the control shown in FIG. 14, unlike the control shown in FIG. 13, the backlight source 905 is emitted only while the left or right frame image is viewed. Therefore, the control shown in FIG. 14 is superior to the control shown in FIG. 13 in terms of saving energy.

The left shutter 951 is opened after the liquid crystal panel 904 displays the left frame image, which is viewed by the left eye, and before a scanning operation of the right video signal to display the right frame image. Likewise, the right shutter 952 is opened after the liquid crystal panel 904 displays the right frame image, which is viewed by the right eye, and before a scanning operation of the left video signal to display the left frame image.

As shown in FIGS. 13 and 14, the scanning operation of the left and/or right video signals starts from the top of the liquid crystal panel 904. Therefore, the scanning operation of the left and/or right video signals becomes later at the bottom of the liquid crystal panel 904 than at the top of the liquid crystal panel 904.

It takes long for liquid crystals to respond to the left and/or right image signals although the response time depends on a type of the displayed image. For example, if there is a difference between brightness levels of a pixel to render frame images sequentially displayed, it takes long for the liquid crystals to respond.

If the left or right shutter 951, 952 is opened after the display of the left or right frame image completes, the open period of the left or right shutter 951, 952 becomes short because of the long response time of the liquid crystals. As a result, the viewer perceives a dark stereoscopic image displayed on the liquid crystal panel 904.

If the left shutter 951 is opened before the display of the left frame image completes, the viewer views the left frame image influenced and mixed by the previously displayed right frame image. Likewise, if the right shutter 952 is opened before the display of the right frame image completes, the viewer views the right frame image influenced and mixed by the previously displayed left frame image. Such mixture of the left and right frame images is called “crosstalk”. Since the delayed scanning operation of the left and/or right image signals and the long response time of the liquid crystals happen to the bottom of the liquid crystal panel 904, a mixture amount of the previous frame image (left or right frame image) is particularly large at a lower portion of the liquid crystal panel 904. Thus, it may become difficult for the viewer to stereoscopically perceive the frame image displayed in the lower portion of the liquid crystal panel 904.

Patent Document 1: JP S62-133891 A

Patent Document 2: JP 2009-25436 A

### DISCLOSURE OF THE INVENTION

It is an object of the present invention to provide a display device and a video viewing system which may control the crosstalk between left and right frame images.

A display device according to one aspect of the present invention includes: a liquid crystal panel configured to switch between a left frame image, which is viewed by a left eye, and a right frame image, which is viewed by a right eye, to alternately display the left and right frame images on a display surface with time; and a liquid crystal driver which scans and drives the liquid crystal panel with a frame image signal to display the left or right frame image over the display surface, wherein the liquid crystal driver executes a first scanning operation over the display surface and a second scanning operation over the display surface after the first scanning operation, the first scanning operation is executed in a shorter period than the second scanning operation, and the first scanning operation is executed at a higher writing frequency of the frame image signal by the liquid crystal driver than the second scanning operation.

A video viewing system according to another aspect of the present invention includes: a display device configured to display a left frame image, which is viewed by a left eye, and a right frame image, which is viewed by a right eye; and an eyeglass device including a left filter, which adjusts a light amount reaching the left eye so that the left frame image is viewed, and a right filter, which adjusts a light amount reaching the right eye so that the right frame image is viewed, wherein the display device includes: a liquid crystal panel configured to switch between the left and right frame images to alternately display the left and right images on a display surface with time; and a liquid crystal driver which scans and drives the liquid crystal panel with a frame image signal to display the left or right frame image over the display surface, wherein the liquid crystal driver executes a first scanning operation over the display surface, and a second scanning operation over the display surface after the first scanning operation, the first scanning operation is executed in a shorter period than the second scanning operation, and the first scanning operation is executed at a higher writing frequency of the frame image signal by the liquid crystal driver than the second scanning operation.

The display device and the video viewing system according to the present invention may control the crosstalk between left and right frame images.

### BRIEF DESCRIPTION OF THE DRAWINGS

FIG. 1 is a schematic block diagram showing a configuration of a video viewing system according to the first embodiment.

FIG. 2 is a schematic view showing the video viewing system depicted in FIG. 1.

FIG. 3A is a graph showing a first scanning operation by a liquid crystal driver of the display device depicted in FIG. 1.

FIG. 3B is a graph showing a second scanning operation by the liquid crystal driver of the display device depicted in FIG. 1.

FIG. 4 is a schematic control timing chart showing a control of the video viewing system depicted in FIG. 1.

FIG. 5A is a graph showing effects of the first and second scanning operations by the liquid crystal driver depicted in FIG. 4.

FIG. 5B is a graph showing effects of the first and second scanning operations by the liquid crystal driver depicted in FIG. 4.

FIG. 5C is a graph showing effects of the first and second scanning operations by the liquid crystal driver depicted in FIG. 4.

FIG. 6 is a schematic block diagram showing a configuration of a video viewing system according to the second embodiment.

FIG. 7 is a schematic view showing generation of a common line signal by an output portion of the display device depicted in FIG. 6.

FIG. 8 is a schematic view showing generation of a common line signal by the output portion of the display device depicted in FIG. 6.

FIG. 9A is a graph showing the first scanning operation by the liquid crystal driver of the display device depicted in FIG. 6.

FIG. 9B is a graph showing the second scanning operation by the liquid crystal driver of the display device depicted in FIG. 6.

FIG. 10A is a schematic timing chart showing the first scanning operation by the liquid crystal driver of the display device depicted in FIG. 6.

FIG. 10B is a schematic timing chart showing the second scanning operation by the liquid crystal driver of the display device depicted in FIG. 6.

FIG. 11A is a graph showing effects of the first and second scanning operations by the liquid crystal driver depicted in FIGS. 10A and 10B.

FIG. 11B is a graph showing effects of the first and second scanning operations by the liquid crystal driver depicted in FIGS. 10A and 10B.

FIG. 11C is a graph showing effects of the first and second scanning operations by the liquid crystal driver depicted in FIGS. 10A and 10B.

FIG. 12 is a schematic block diagram showing a configuration of a conventional video viewing system.

FIG. 13 is a control timing chart showing an exemplary control of the conventional video viewing system.

FIG. 14 is another control timing chart showing an exemplary control of the conventional video viewing system.

### DETAILED DESCRIPTION OF THE INVENTION

A display device and a video viewing system according to various embodiments are described with reference to the accompanying drawings. In the following embodiments, the same elements are denoted with the same reference symbols. To clarify description, redundant description may be omitted as appropriate. Configurations, arrangements and shapes shown in the drawings, and the description about the drawings are merely intended to make the display device and the video viewing system easily understood. The principles of the display device and the video viewing system are not restricted by these illustrations and descriptions.

### First Embodiment

### Configuration of Video Viewing System

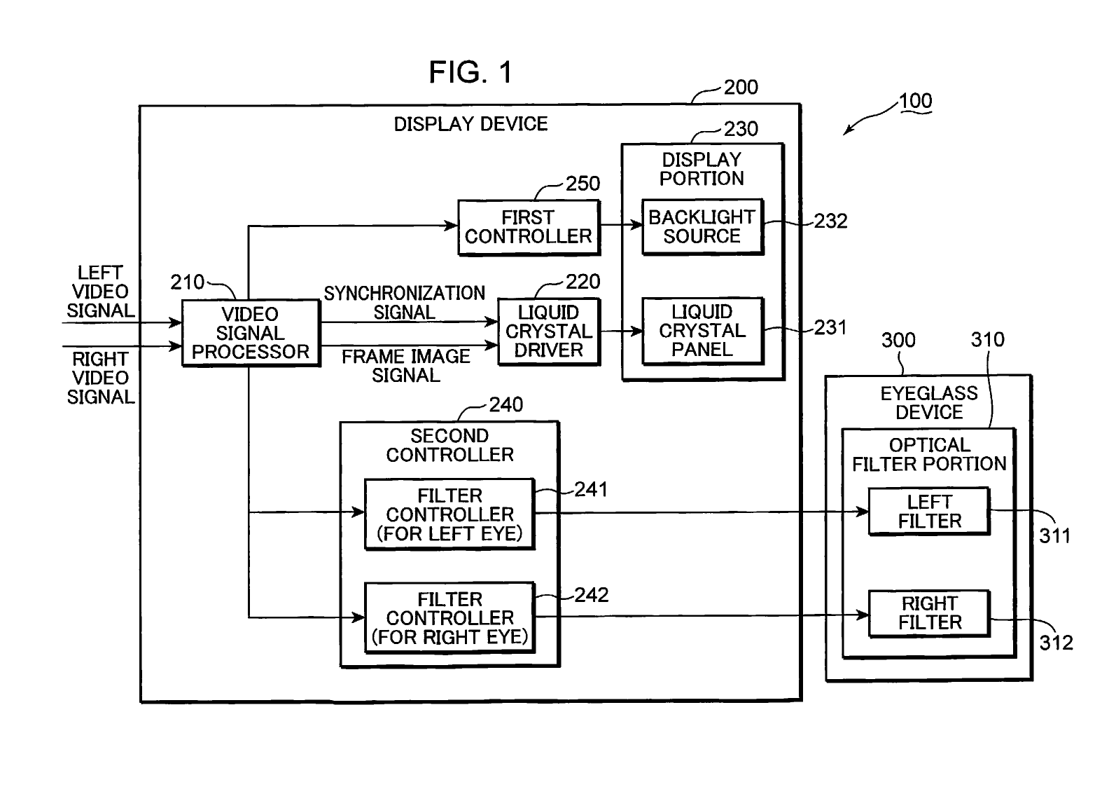

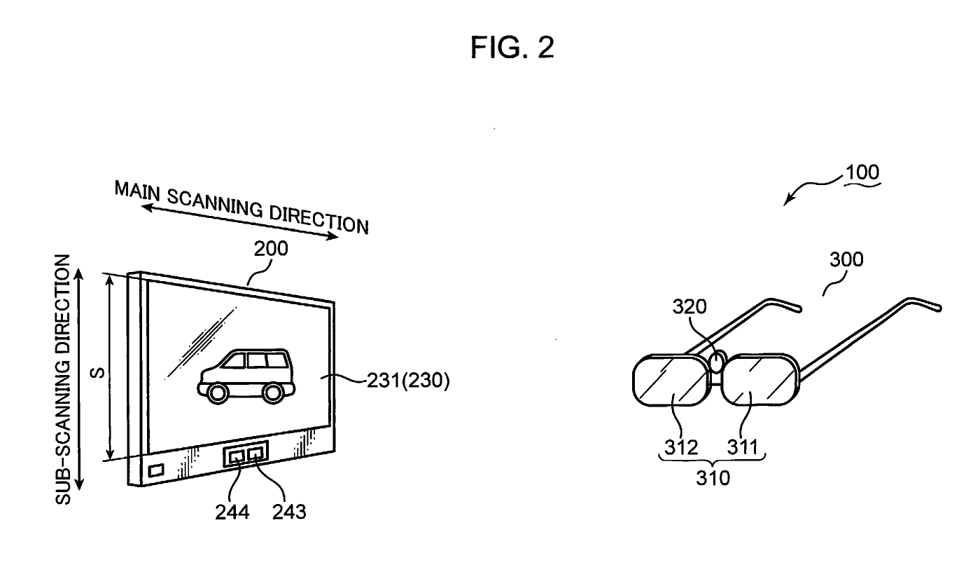

FIG. 1 is a schematic block diagram showing a configuration of a video viewing system according to the first embodiment. FIG. 2 is a schematic view of the video viewing system shown in FIG. 1. The configuration of the video viewing system is described with reference to FIGS. 1 and 2.

The video viewing system 100 has a display device 200 for displaying a frame image including a left frame image, which is viewed by the left eye, and a right frame image, which is viewed by the right eye, and an eyeglass device 300 which assists in viewing the left and right frame images displayed by the display device 200. The eyeglass device 300 performs stereovision assistance in synchronism with the display of the left and right frame images by the display device 200, so that the viewer views the left and right frame images with the left and right eyes, respectively. Thus, the viewer may stereoscopically perceive the frame images (left and right frame images) displayed by the display device 200 through the eyeglass device 300 (The viewer perceives an object rendered in the left and right frame images as if the object came out or in the display surface on which the left and right frame images are displayed).

The eyeglass device 300, which looks like glasses used for adjusting vision, has an optical filter portion 310 which includes a left filter 311 situated in front of the left eye of the viewer and a right filter 312 situated in front of the right eye of the viewer. The left and right filters 311, 312 include an optical element configured to adjust a light amount which reaches the left eye of the viewer (hereafter called “left light amount”) from an image displayed by the display device 200, and an optical element configured to adjust a light amount which reaches from an image to the right eye of the viewer (hereafter called “right light amount”), respectively. A shutter element configured to close an optical path which transmits to the left or right eye of the user (e.g. liquid crystal shutter), a deflection element which deflects the light transmitted to the left or light eye of the viewer (e.g. liquid crystal filter), and another optical element configured to adjust the light amount may be preferably used for the left and right filters 311, 312. The left filter 311 is controlled to increase the left light amount in synchronism with the display of the left frame image and to decrease the left light amount in synchronism with the display of the right frame image. Likewise, the right filter 312 is controlled to increase the right light amount in synchronism with the display of the right frame image and to decrease the right light amount in synchronism with the display of the left frame image.

The display device 200 has a video signal processor 210, a liquid crystal driver 220, a display portion 230, a first controller 250 and a second controller 240.

Video signals (left and right video signals) at a vertical synchronization frequency used as a control base are input to the video signal processor 210. The video signal processor 210 alternately outputs the left video signal (hereafter called “L signal”) and the right video signal (hereafter called “R signal”) which are input at N times (N is natural number) as high frequency as the vertical synchronization frequency, which is used as the control base. In the present embodiment, the input video signal at 60 Hz is converted into the L and R signals at 120 Hz. The L and R signals generated by the conversion are output to the liquid crystal driver 220. In addition, the video signal processor 210 outputs control signals to the first controller 250 in synchronism with the output of the L and R signals. The first controller 250 controls a backlight source 232 of the display portion 230 in response to the control signals from the video signal processor 210. The video signal processor 210 outputs control signals to control the second controller 240 in synchronism with the output of the L and R signals. The second controller 240 controls the optical filter portion 310 in response to the control signals from the video signal processor 210. The control signals which are output to the first and/or second controllers 250, 240, may be the L and/or R signals after the conversion by the video signal processor 210. Alternatively, the vertical synchronization signal at 120 Hz of the L and/or R signals may be used.

A video signal, which contains video information between one vertical synchronization signal contained in the L signal and the subsequent vertical synchronization signal that is input next to the one vertical synchronization signal, is called “left frame image signal” in the following descriptions of the present embodiment. A video signal, which contains video information between one vertical synchronization signal contained in the R signal and the subsequent vertical synchronization signal that is input next to the one vertical synchronization signal, is called “right frame image signal” in the following descriptions. The left frame image signal is used to render the left frame image. Likewise, the right frame image signal is used to render the right frame image.

The display portion 230 has a liquid crystal panel 231 which switches between the left and right frame images to alternately display them with time by means of liquid crystals; and the backlight source 232 which irradiates light onto the liquid crystal panel 231. The liquid crystal driver 220 scans the liquid crystal panel 231 with the frame image signal (left or right frame image signal) in the main scanning direction and the sub-scanning direction to drive the liquid crystals of the liquid crystal panel 231. As shown in FIG. 2, the horizontal direction of the liquid crystal panel 231 is exemplified as the main scanning direction of the frame image signal. The vertical direction of the liquid crystal panel 231 is exemplified as the sub-scanning direction of the frame image signal. The interval in the sub-scanning direction used to display the frame image (interval from the top edge to bottom edge of the liquid crystal panel 231) is exemplified as the sub-scanning interval S. The liquid crystal driver 220 scans the liquid crystal panel 231 with the left and right frame image signals alternately. Thus, the left and right frame images are alternately displayed on the liquid crystal panel 231 with time.

If the frame image signals contained in the L and/or R signals are input from the image signal processor 210 to the liquid crystal driver 220 in the present embodiment, the liquid crystal driver 220 executes the first scanning operation to start driving the liquid crystals throughout the sub-scanning interval S, and the second scanning operation to display the frame image on the liquid crystal panel 231. The second scanning operation is executed after the first scanning operation. As described later, the liquid crystal driver 220 executes the first scanning operation in a shorter period than the second scanning operation. Therefore, a sufficiently long time may be secured for the second scanning operation subsequent to the first scanning operation before the left or right filter 311, 312 increases the left or right light amount.

The liquid crystal driver 220 converts the L and R signals into a display format of the liquid crystal panel 231 in response to the vertical and horizontal synchronization signals contained in the L and R signals. The liquid crystal driver 220 executes the first and second scanning operations with the converted frame image signals of the L and R signals for the display of each frame image on the liquid crystal panel 231.

The liquid crystal panel 231 includes several scanning lines which extend in the main scanning direction and are aligned in the sub-scanning direction. The frame image signal defined by the vertical synchronization signal contained in the L and R signals includes several line signals which correspond to the scanning lines of the liquid crystal panel 231. The line signal is defined by the horizontal synchronization signal contained in the frame image signal. A video signal, which contains the video information between one horizontal synchronization signal and the subsequent horizontal synchronization signal next to the one horizontal synchronization signal, is used as the line signal which corresponds to each scanning line. Each line signal corresponding to each scanning line is sequentially written by the liquid crystal driver 220 from an upper scanning line to a lower scanning line. As a result, the liquid crystals aligned along each scanning line are sequentially driven to display the frame image on the liquid crystal panel 231.

The liquid crystal panel 231 modulates light entering from the rear surface in response to the input L and R signals by means of the liquid crystals driven by the liquid crystal driver 220. Accordingly, the liquid crystal panel 231 alternately displays the left and right frame images, which are viewed by the left and right eyes, respectively. Various driving methods such as IPS (In Plane Switching), VA (Vertical Alignment) and TN (Twisted Nematic) may be suitably used for the liquid crystal panel 231.

The backlight source 232 irradiates light from the rear surface of the liquid crystal panel 231 onto the display surface of the liquid crystal panel 231. Several light emitting diodes (LEDs), which are two-dimensionally arrayed to perform surface emission (not shown), are used as the backlight source 232 in the present embodiment. Alternatively, several fluorescent tubes arrayed to performed surface emission may be used as the backlight source 232. The light emitting diodes and the fluorescent tubes used as the backlight source 232 may be situated on the edge of the liquid crystal panel 231 to cause the surface emission (edge type).

The first controller 250 outputs an emission control signal in response to a control signal at 120 Hz which is output from the video signal processor 210. The backlight source 232 may turn ON/OFF in response to the emission control signal.

The second controller 240 controls an optical filter portion 310 of the eyeglass device 300 in correspondence to the display period of the left and right frame images. The second controller is exemplified as the controller which controls the eyeglass device 300 in the present embodiment.

The second controller 240 has a left filter controller 241 (hereafter called “L filter controller 241”), which controls the left filter 311, and a right filter controller 242 (hereafter called “R filter controller 242), which controls the right filter 312. If the liquid crystal panel 231 alternately displays the left and right frame images at 120 Hz, for example, the L filter controller 241 controls the eyeglass device 300 so that the left filter 311 adjusts (increases/decreases) the left light amount at 60 Hz cycle. Likewise, the R filter controller 242 controls the eyeglass device 300 so that the right filter 312 adjusts (increases/decreases) the right light amount at 60 Hz cycle.

As shown in FIG. 2, in the present embodiment, the display device 200 has a first transmitter 243 configured to transmit a first synchronization signal, which synchronizes with the display of the left frame image, and a second transmitter 244 configured to transmit a second synchronization signal, which synchronizes with the display of the right frame image. The eyeglass device 300 also has a receiver 320 which is situated between the left and right filters 311, 312. The receiver 320 receives the first and second synchronization signals. It is preferable that the first synchronization signal is different in waveform from the second synchronization signal. The receiver 320 identifies the first and second synchronization signals on the basis of the waveform of the received synchronization signal. Thus, the eyeglass device 300 operates the left filter 311 in response to the first synchronization signal. The eyeglass device 300 also operates the right filter 312 in response to the second synchronization signal. Other known communication technologies and other known signal processing technologies may be used for the wireless communication of the synchronization signals between the display device 200 and the eyeglass device 300, and internal processes to the synchronization signals (first and second synchronization signals) by the eyeglass device 300. Alternatively, the communication of the synchronization signals (first and second synchronization signals) between the display device 200 and the eyeglass device 300 may be performed via a cable. The first and second transmitters 243, 244, which transmit the first and second synchronization signals in synchronism with the display of the left and right frame images, respectively, may be one common transmission unit. In this case, the synchronization signals may be shared so that the left and right frame images may be alternately displayed in synchronism with the rise of the signal.

The L and R filter controllers 241, 242 determine phases of the increase/decrease cycle of the left and right light amounts by the left and right filters 311, 312, in response to the control signal from the video signal processor 210, respectively. The L and R filter controllers 241, 242 output the first and second synchronization signals, respectively, in response to the determined phase. The left and right filters 311, 312 increase/decrease the left and right light amounts in synchronism with the display of the left and right frame images in response to the first and second synchronization signals, respectively.

The second controller 240 may take account of response characteristics of the liquid crystal panel 231 and the crosstalk (mutual interference) between the displayed left and right frame images to determine a period length, during which the left filter 311 increases the left light amount, and a period length, during which the right filter 312 increases the right light amount, (hereafter called “light volume-up period”), and the timing (phase) of the light volume-up period, respectively. The L filter controller 241 controls the length and the timing of the light volume-up period for the left light amount. The R filter controller 242 controls the length and the timing of the light volume-up period for the right light amount.

The first controller 250, which operates in response to the control signal at 120 Hz of the video signal processor 210, outputs an emission control signal for causing the backlight source 232 to emit light in synchronism with the light volume adjustment by the left and right filters 311, 312. The backlight source 232 may be turned ON/OFF in response to the emission control signal. The backlight source 232 is always ON under the control of the first controller 250 in the present embodiment. Therefore, the timing and the length of the viewing period, during which the viewer may view a frame image, are determined by the operation of the optical filter portion 310 of the eyeglass device 300.

Alternatively, the first controller 250 may turn the backlight source 2320N in a period substantially matching with a part of the light volume-up period or the entire light volume-up period adjusted by the second controller 240, and turn the backlight source 232 OFF in the other periods. Under this lighting control of the backlight source 232 by the first controller 250, the timing and length of the viewing period, during which the viewer may view a frame image, are determined by the lighting operation of the backlight source 232.

### (Scanning Operation)

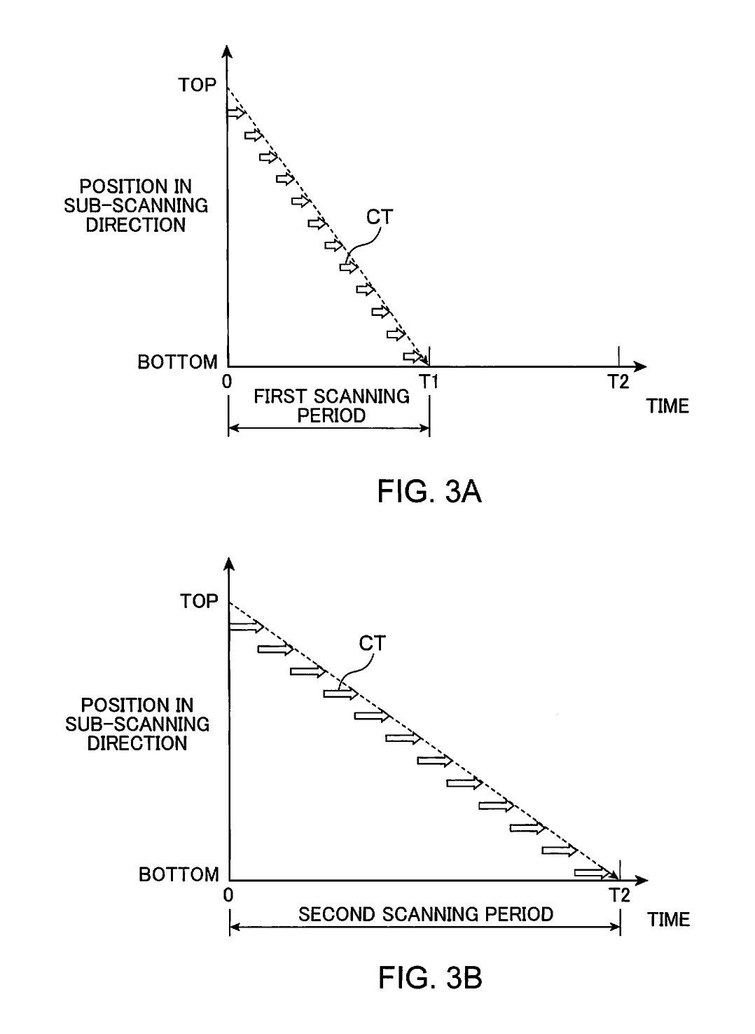

FIGS. 3A and 3B are schematic graphs showing the first and second scanning operations used for the present embodiment. FIG. 3A is the schematic graph showing the first scanning operation. FIG. 3B is the schematic graph showing the second scanning operation. The scanning operation by the liquid crystal driver 220 is described with reference to FIGS. 1, 3A and 3B.

The abscissa of the graphs in FIGS. 3A and 3B is the time axis. The ordinate of the graphs in FIGS. 3A and 3B represents a position of the liquid crystal panel 231 in the sub-scanning direction. The arrow CT shown in the graphs in FIGS. 3A and 3B indicates a time of applying voltage, which is applied to each pixel along each scanning line aligned in the sub-scanning direction of the liquid crystal panel 231. To make the descriptions easily understood, the frame image having a single color is displayed on the liquid crystal panel 231 by the scanning operation shown in FIGS. 3A and 3B. Therefore, the length of the voltage applying time (i.e., the length of the arrow CT) for each pixel of the liquid crystal panel 231 is constant in the first scanning period. Likewise, the length of the voltage applying time (i.e., the length of the arrow CT) for each pixel of the liquid crystal panel 231 is constant in the second scanning period.

The liquid crystal driver 220 sequentially writes line signals from an upper scanning line of the liquid crystal panel 231. Therefore, as shown by the arrow CT in FIGS. 3A and 3B, the voltage application timing in writing the line signals delays as the scanning lines are situated at a lower position.

As described above, the liquid crystal driver 220 executes the first and second scanning operations to display the frame image on the liquid crystal panel 231. The liquid crystal display portion 220 performs the first scanning operation with the frame image signal at a higher writing frequency than the second scanning operation performed by the liquid crystal driver 220. The writing frequency in the second scanning operation is set to a value which may secure a voltage application time long enough to display the frame image.

As shown in FIG. 3A, a length of the first scanning period from the start of writing a line signal to the uppermost scanning line to the completion of writing a line signal to the lowermost scanning line, is “T1” in the first scanning operation. As shown in FIGS. 3A and 3B, a length of the second scanning period from the start of writing a line signal to the uppermost scanning line to the completion of writing a line signal to the lowermost scanning line is “T2” in the second scanning operation. Due to the difference in writing frequency between the first and second scanning operations, the length “T1” of the first scanning period is shorter than the length “T2” of the second scanning period. For example, if the writing frequency in the first scanning operation is twice as high as the writing frequency in the second scanning operation, the length “T1” of the first scanning period is ½ times as long as the length “T2” of the second scanning period.

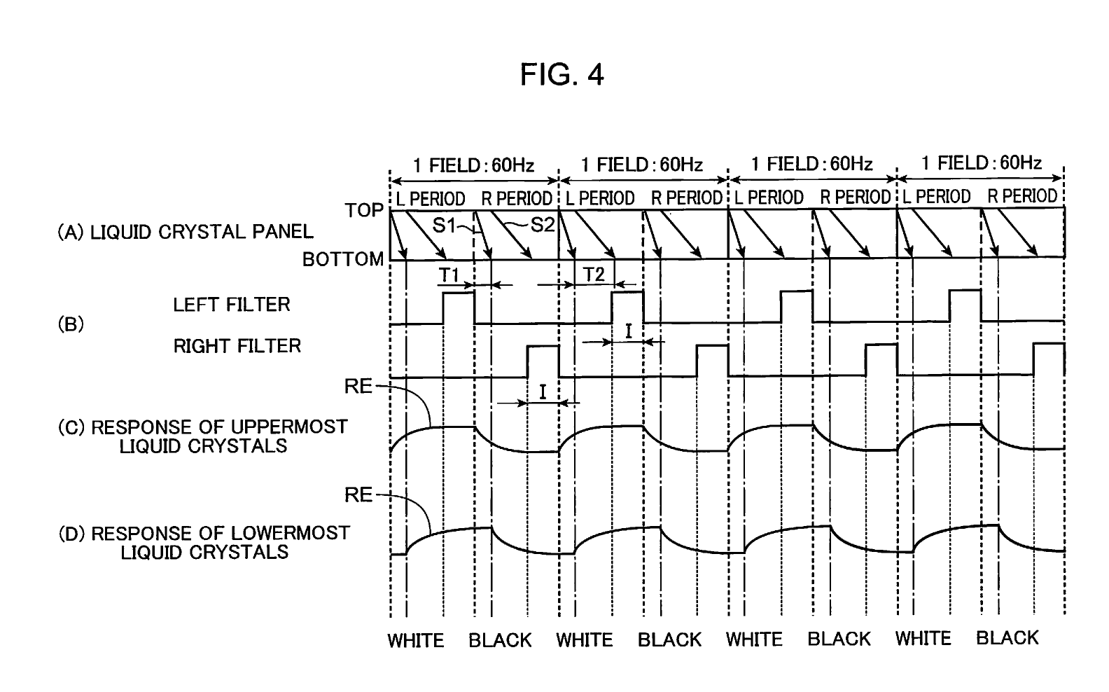

FIG. 4 is a schematic control timing chart showing control of the video viewing system 100. Section (A) in FIG. 4 shows the image scanning timing by the liquid crystal panel 231. Section (B) in FIG. 4 shows changes in the left and right light amounts which are adjusted by the left and right filters 311, 312 of the eyeglass device 300, respectively. Section (C) in FIG. 4 shows response of the liquid crystals which start the response first by the scanning operation of the liquid crystal driver 220 (liquid crystals on the uppermost scanning line in the liquid crystal panel 231). Section (D) in FIG. 4 shows the response of the liquid crystals which start the response last by the scanning operation of the liquid crystal driver 220 (liquid crystals on the lowermost scanning line in the liquid crystal panel 231). The scanning operation by the liquid crystal driver 220 is further described with reference to FIG. 1 and FIGS. 3A to 4.

As shown in FIG. 4, a period of one field (60 Hz) is equally divided into a left scanning period (hereafter “L period”) and a right scanning period (hereafter “R period”). In the L period, a left frame image signal is used for the scanning operation. In the R period, a right frame image signal is used for the scanning operation. To make the descriptions easily understood, the left frame image is a white image whereas the right frame image is a black image.

The arrow S1 shown in section (A) in FIG. 4 indicates the first scanning operation of the liquid crystal driver 220. The arrow S2 shown in section (A) in FIG. 4 indicates the second scanning operation of the liquid crystal driver 220.

The first scanning operation is started at the switching timing between the L and R periods. The liquid crystal driver 220 sequentially writes line signals contained in the frame image signal from the uppermost scanning line in the liquid crystal panel 231. A length of the first scanning period from the start to the completion of the first scanning operation is “T1” as described with reference to FIGS. 3A and 3B.

The second scanning operation is started immediately after the completion of the first scanning operation. In the second scanning operation, the liquid crystal driver 220 reuses the frame image signal, which has the same image information as the frame image signal used for the first scanning operation. Like the first scanning operation, the liquid crystal driver 220 sequentially writes a line signal from the uppermost scanning line in the liquid crystal panel 231. A length of the second scanning period, from the start to the completion of the second scanning operation is “T2” as described with reference to FIGS. 3A and 3B.

The chart lines shown in section (B) in FIG. 4 indicate the increase/decrease of the left and right light amounts. The left filter 311 increases the left light amount immediately after or at the same time as the completion of the second scanning operation in the L period under the control of the L filter controller 241. The left filter 311 decreases the left light amount immediately before or at the same time as the start of the first scanning operation in the R period. Likewise, the right light amount is increased by the right filter 312 just after or at the same time as the completion of the second scanning operation in the R period under the control of the R filter controller 242. The right light amount is decreased by the right filter 312 immediately before or at the same time as the start of the first scanning operation in the L period. Thus, the viewer may view the left or right frame image during the light volume-up period I (while the left or right light amount is increased) defined by the second controller 240.

The chart lines RE shown in the sections (C) and (D) in FIG. 4 indicate a transmitted light amount which transmits through the liquid crystal layer of the liquid crystal panel 231. As shown in the section (C) of FIG. 4, the liquid crystals driven by the line signal, which is written to the uppermost scanning line in the liquid crystal panel 231, start the response just after the start of the first scanning operation. As shown in the section (D) of FIG. 4, the liquid crystals driven by the line signal, which is written to the lowermost scanning line in the liquid crystal panel 231, start the response immediately after the completion of the first scanning operation.

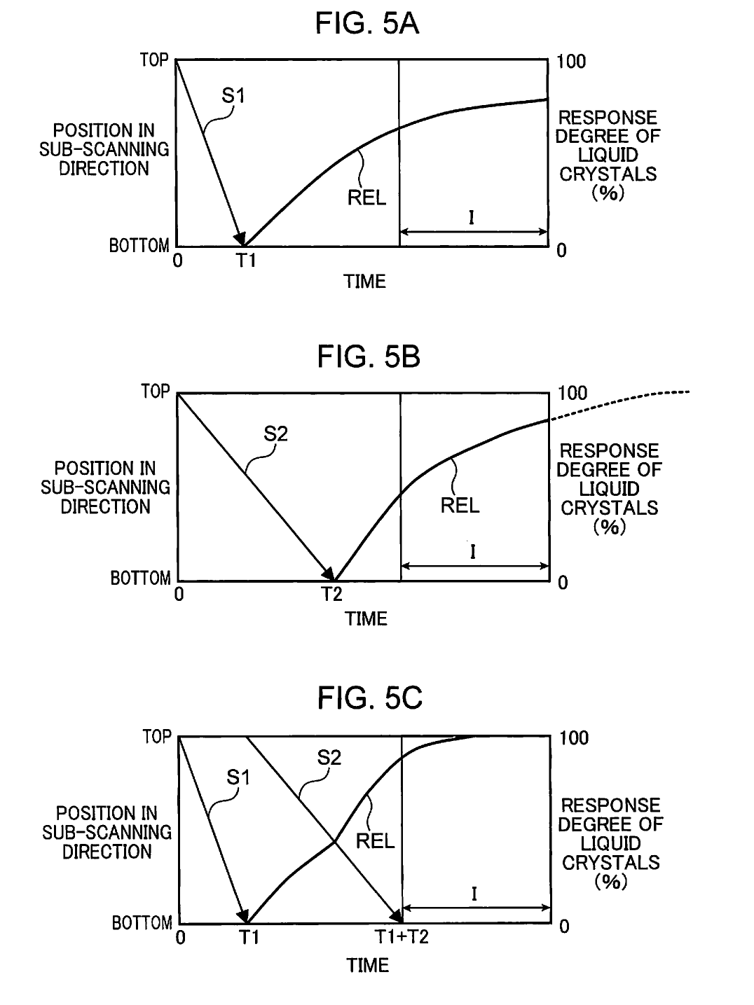

FIGS. 5A to 5C are schematic graphs showing effects of the first and second scanning operations to display one frame image. FIG. 5A shows response of the liquid crystals under execution of only the first scanning operation for one frame image. FIG. 5B shows response of the liquid crystals under execution of only the second scanning operation for one frame image. FIG. 5C shows response of the liquid crystals under executions of the first and second scanning operations for one frame image. The effects of the first and second scanning operations are described with reference to FIG. 1 and FIGS. 3A to 5C.

The abscissa of the graphs in FIGS. 5A to 5C is the time axis. The ordinate of the graphs in FIGS. 5A to 5C shows positions in the liquid crystal panels 231 in the sub-scanning direction. The arrow S1 shown in FIGS. 5A and 5C indicates the first scanning operation, like section (A) in FIG. 4. The arrow S2 depicted in FIGS. 5B and 5C shows the second scanning operation, like section (A) in FIG. 4.

In the scanning operation shown in FIG. 5A, the line signal is written to the uppermost scanning line in the liquid crystal panel 231 from time “0” at a first writing frequency. The liquid crystal driver 220 sequentially writes line signals to lower scanning lines at the first writing frequency. At the time “T1”, it is completed to write the line signal to the lowermost scanning line in the liquid crystal panel 231.

In the scanning operation shown in FIG. 5B, the line signal is written to the uppermost scanning line in the liquid crystal panel 231 from time “0” at a second writing frequency. The liquid crystal driver 220 sequentially writes the line signals to lower scanning lines at the second writing frequency. At the time “T2”, it is completed to write the line signal to the lowermost scanning line in the liquid crystal panel 231.

In the first scanning operation shown in FIG. 5C, the line signal is written to the uppermost scanning line in the liquid crystal panel 231 from time “0”. As mentioned above, the line signal is written in the first scanning operation at the first writing frequency, which is higher than the writing frequency to write the line signal in the second scanning operation. The liquid crystal driver 220 sequentially writes the line signals to lower scanning lines at the first writing frequency. At the time “T1”, it is completed to write the line signal to the lowermost scanning line in the liquid crystal panel 231.

The liquid crystal driver 220 then executes the second scanning operation. As mentioned above, the line signal is written in the second scanning operation at the second writing frequency, which is adjusted so that a frame image may be appropriately displayed. From the time “T1”, a line signal is written to the uppermost scanning line in the liquid crystal panel 231 at the second writing frequency. Then, the liquid crystal driver 220 sequentially writes line signals to lower scanning lines at the second writing frequency. At the time “T1+T2”, it is completed to write the line signal to the lowermost scanning line in the liquid crystal panel 231.

The right ordinate of the graphs in FIGS. 5A to 5C indicates a degree of response of the liquid crystals driven by the line signal written to the lowermost scanning line in the liquid crystal panel 231. The chart line REL shown in the graphs in FIGS. 5A to 5C indicates a degree of response of the lowest liquid crystals in the liquid crystal panel 231. The chart line REL shown in the graphs in FIGS. 5A to 5C indicates a degree of response of the liquid crystals in the L period (a period for displaying the white left frame image) shown in FIG. 4.

The value “100” on the right ordinates of the graphs in FIGS. 5A to 5C means a degree of response of liquid crystals at which the liquid crystals allows transmission of light from the backlight source 232 so that the transmitted light amount becomes equivalent to a light amount required for displaying a color defined by the line signal written to the lowermost scanning line in the liquid crystal panel 231. The value “0” indicates a degree of response of liquid crystals in response to the previous frame image signal.

As the arrow CT in FIGS. 3A and 3B indicates, the writing time in the first scanning operation is insufficient for the charging voltage of a pixel to reach a target value. Hence, if only the first scanning operation is executed for displaying the frame image, as shown in FIG. 5A, the degree of response of the liquid crystals do not reach the target value even after a sufficient time elapses.

If only the second scanning operation is executed to display the frame image, as shown in FIG. 5B, the liquid crystals along the lowermost scanning line start responses at the time “T2”, which is relatively late. As a result, the liquid crystals along the lowermost scanning line do not reach a sufficient response degree at the beginning of the light volume-up period I.

If the liquid crystal driver 220 executes the first scanning operation as shown in FIG. 5C, the liquid crystals along the lowermost scanning line start responses at the time “T1”. If the liquid crystal driver 220 then executes the second scanning operation from time “T1”, the liquid crystals after responding by a predetermined amount due to the first scanning operation, further respond to reach the target response degree by the second scanning operation. As a result, the liquid crystals along the lowermost scanning line may reach a desired response degree in a relatively short time. If the first writing frequency is twice as high as the second writing frequency, the response start time “T1” of the liquid crystals in FIG. 5C becomes half the response start time “T2” of the liquid crystals in FIG. 5B. The value of the first writing frequency is appropriately determined in response to the response start time of the liquid crystals and the degree of response of the liquid crystals implemented by the first scanning operation.

As shown in FIG. 5C, if the light volume-up period I is started at time “T1+T2”, the liquid crystals driven by the first and second scanning operations reach a relatively high degree of response. As mentioned above, the liquid crystals driven only by the first scanning operation have a relatively low degree of response, due to the insufficient writing time. The liquid crystals driven only by the second scanning operation have a low degree of response, due to the delay in the start of response. On the other hand, if the liquid crystal driver 220 executes the first and second scanning operations, crosstalk may be preferably decreased even in a portion of a frame image displayed in the display area of the liquid crystal panel 231 by the scanning operation at a relatively late timing. Thus, the viewer may view frame images with little crosstalk.

### Second Embodiment

### Configuration of Video Viewing System

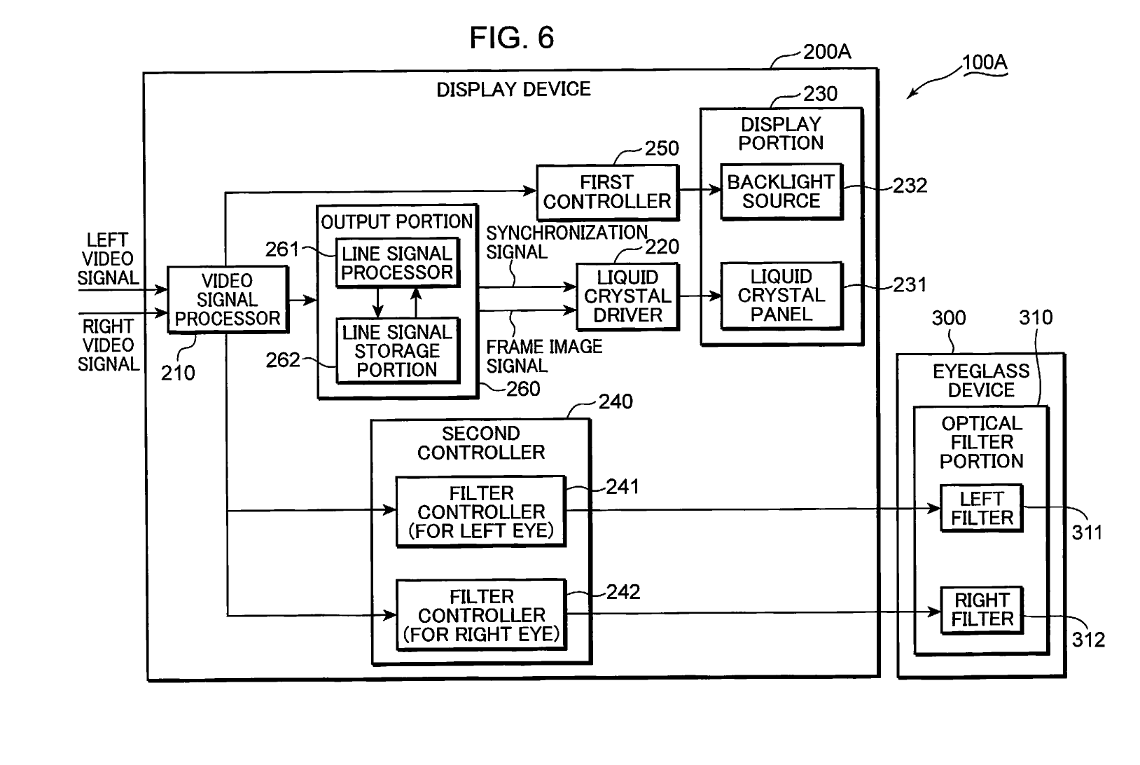

FIG. 6 is a schematic block diagram showing a configuration of a video viewing system 100A according to the second embodiment. Differences between the video viewing system 100A according to the second embodiment and the video viewing system 100 according to the first embodiment is described.

The video viewing system 100A has the eyeglass device 300, which is the same as that of the first embodiment, and a display device 200A which alternately displays the left and right frame images. The display device 200A has an output portion 260, in addition to the video signal processor 210, the liquid crystal driver 220, the display portion 230, the first controller 250 and the second controller 240, which are the same as those of the display device 200 of the first embodiment.

Like the first embodiment, video signals (left and right video signals) having a vertical synchronization frequency, which is used as a control base, is input to the video signal processor 210. The video signal processor 210 alternately outputs the input left video signal (hereafter called the “L signal”) and the input right video signal (hereafter called the “R signal”) at N times (N is a natural number) as high frequency as the base vertical synchronization frequency. The L and R signals obtained by the conversion are output to the output portion 260.

The output portion 260 outputs first and second frame image signals to the liquid crystal driver 220 so that the liquid crystal driver 220 executes the first and second scanning operations by means of the first and second frame image signals, respectively. In the present embodiment, the liquid crystal driver 220 executes the first scanning operation with the first frame image signals to achieve a lower resolution than the second scanning operation with the second frame image signal.

The output portion 260 includes a line signal processor 261 which processes several line signals defined by the horizontal synchronization signal contained in the frame image signal of the L and/or R signals, and a line signal storage portion 262 which stores the line signals. The line signal processor 261 and the line signal storage portion 262 works together to execute an averaging process or selecting process to the line signals of the frame image signals and generate the first frame image signal as described later.

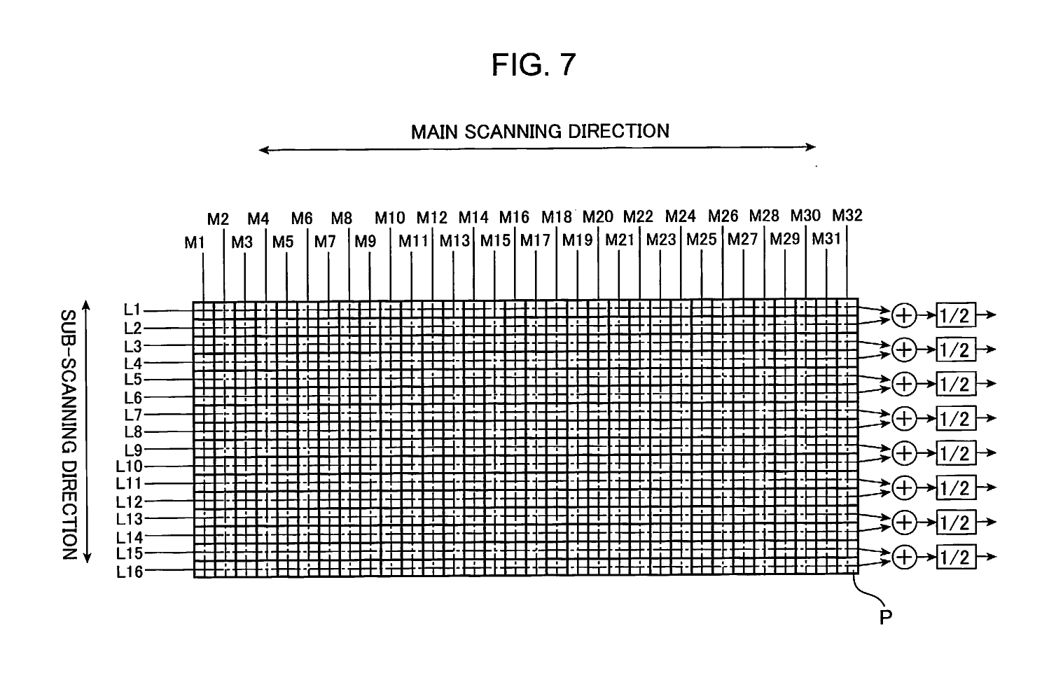

FIG. 7 is a schematic view showing the averaging process to the line signals executed by the output portion 260. The averaging process for the line signals executed by the output portion 260 is described with reference to FIGS. 6 and 7.

FIG. 7 shows several scanning lines L1 to L16 to which the line signals are written. The scanning lines L1 to L16, which extend in the main scanning direction, are aligned substantially in parallel in the sub-scanning direction. Pixels P are aligned along each scanning line. In the present embodiment, groups of pixels P along a pair of the adjacent scanning lines (e.g. a set of the scanning lines L1, L2, a set of the scanning lines L3, L4, and a set of the scanning lines L5, L6) form several display areas, respectively. For example, a portion of the frame image, which is rendered by the line signals written to the set of the scanning lines L1, L2, respectively, is exemplified as the first image portion. A portion of the frame image, which is rendered by the line signals written to the set of the scanning lines L3, L4, respectively, is exemplified as the second image portion. In this case, the line signals, which are written to the set of the scanning lines L1, L2, respectively, are exemplified as the first line signals. The line signals, which are written to the set of the scanning lines L3, L4, respectively, are exemplified as the second line signals. In this case, the set of the scanning lines L1, L2 is exemplified as the first scanning lines while the set of the scanning lines L3, L4 is exemplified as the second scanning lines.

The line signal processor 261 performs signal processes to each set of the scanning lines. The line signal processor 261 stores a line signal corresponding to the scanning line L1 in the line signal storage portion 262. If a line signal corresponding to the scanning line L2 is then input from the video signal processor 210, the line signal processor 261 reads the line signal corresponding to the scanning line L1 from the line signal storage portion 262. The line signal processor 261 averages the line signals corresponding to the scanning lines L1, L2.

In FIG. 7, rows of pixels extending in the sub-scanning direction are denoted with the symbols “M1” to “M32”, to make the description clear. The pixel rows M1 to M32 extending in the sub-scanning direction are aligned in the main scanning direction. In the averaging process of the line signals, the line signal processor 261 averages a value of a line signal corresponding to a pixel P, which is located at the intersection of the pixel row M1 and the scanning line L1, and a value of a line signal corresponding to a pixel P, which is located at the intersection of the pixel row M1 and the scanning line L2, so as to determine a value of a signal for the two pixels P corresponding to the intersection of the pixel row M1 and the scanning line L1 and that of the pixel row M1 and the scanning line L2. As a result, signals having a common value (averaged line signal) are assigned to these two pixels P. The line signal processor 261 repeatedly performs the averaging process for each pixel P located at the intersections of the scanning lines L1, L2 and the pixel rows M2 to M32, and generates a common line signal which is commonly written to the scanning lines L1, L2. The line signal processor 261 executes the same averaging process for the line signals corresponding to the other scanning lines L3 to L16. Thus, several common line signals, which are written to several sets of the scanning lines, respectively, are generated.

A common line signal determined for one set of the scanning lines (e.g. a set of scanning lines L1, L2) exemplified as the first scanning lines is exemplified as the first common line signal. A common line signal determined for another set of the scanning lines (e.g. a set of scanning lines L3, L4) is exemplified as the second common line signal.

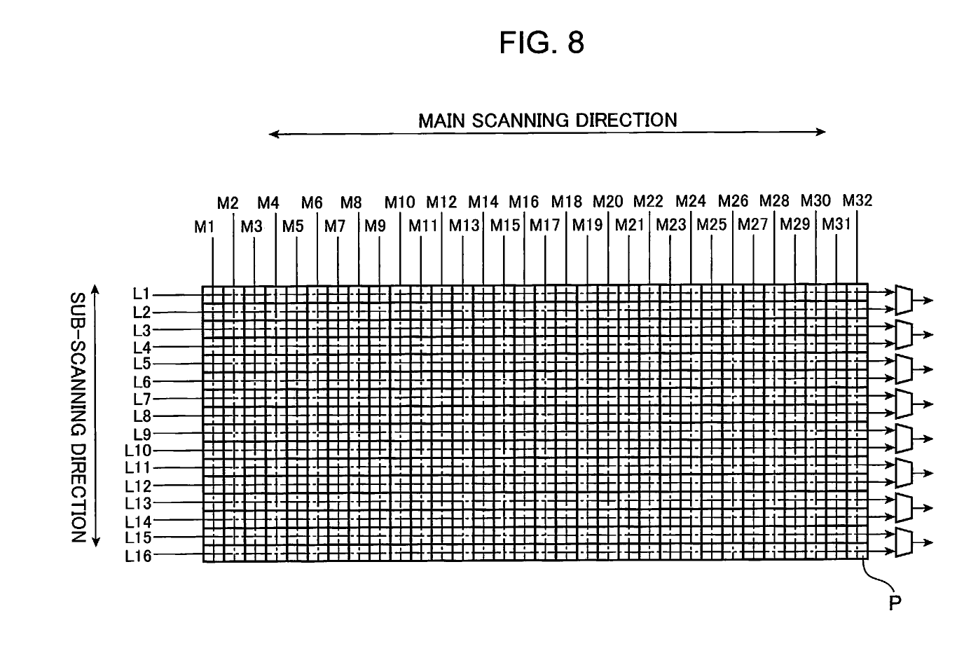

FIG. 8 is a schematic view showing the selecting process for the line signals, which is executed by the output portion 260. The selecting process for the line signals executed by the output portion 260 is described with reference to FIGS. 6 to 8.

The output portion 260 may perform the selecting process for the line signals, instead of the averaging process described with reference to FIG. 7. The arrangement of the scanning lines L1 to L16 and the pixel rows M1 to M32 shown in FIG. 8 is the same as FIG. 7. Instead of the averaging process described with reference to FIG. 7, the line signal processor 261 may select one of the line signals which is input to a set of the scanning lines corresponding to the pixel rows in the main scanning direction for forming each display area, so as to generate a common line signal.

The line signal processor 261 performs signal processes to each set of the scanning lines, like the averaging process described with reference to FIG. 7. For example, the line signal processor 261 stores a line signal corresponding to the scanning line L1 in the line signal storage portion 262. If a line signal corresponding to the scanning line L2 is then input, the line signal processor 261 reads the line signal corresponding to the scanning line L1 from the line signal storage portion 262. The line signal processor 261 performs the selecting process for the line signals corresponding to the scanning lines L1, L2 as well.

In the process for selecting a line signal, for example, the line signal processor 261 compares a value of a line signal corresponding to a pixel P located at the intersection of the pixel row M1 and the scanning line L1 with a value of a line signal corresponding to a pixel P located at the intersection of the pixel row M1 and the scanning line L2, and determines values for the signals corresponding to the two pixels located at the intersections of the scanning lines L1, L2 and the pixel row M1. For example, the line signal processor 261 may determine the value of the common line signal as a greater value (maximum value) or a smaller value (minimum value) between the values of the line signal corresponding to the pixel P located at the intersection of the scanning line L1 and the pixel row M1, and the value of the line signal corresponding to the pixel P located at the intersection of the scanning line L2 and the pixel row M1. The line signal processor 261 repeatedly performs the selecting process to generate the common line signals, which are written to both the scanning lines L1, L2, for the pixels P located at the intersections of the scanning lines L1, L2 and the pixel rows M2 to M32. The line signal processor 261 executes the same selecting process for the line signals corresponding to the other scanning lines L3 to L16 to generate several common line signals, which are written to sets of the scanning lines.

Alternately, the line signals which are input to the odd number scanning lines (scanning lines L1, L3, L5 . . . ) or even number scanning lines (scanning lines L2, L4, L6 . . . ) may be used as the common line signal. The line signal processor 261 may output a line signal which is input to a predetermined scanning line, as the common line signal.

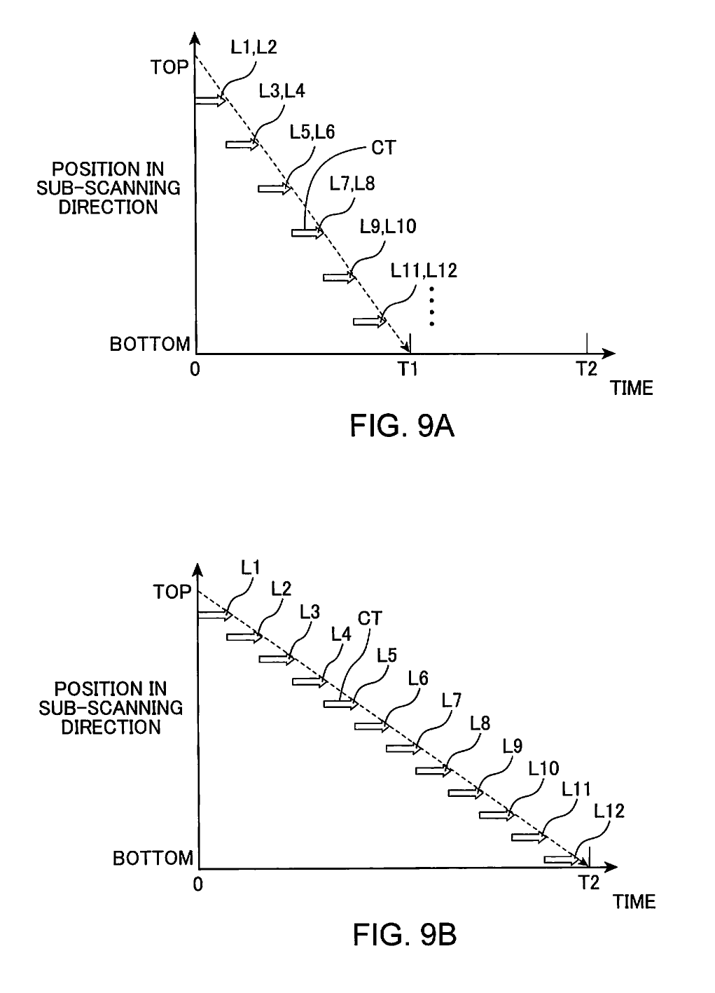

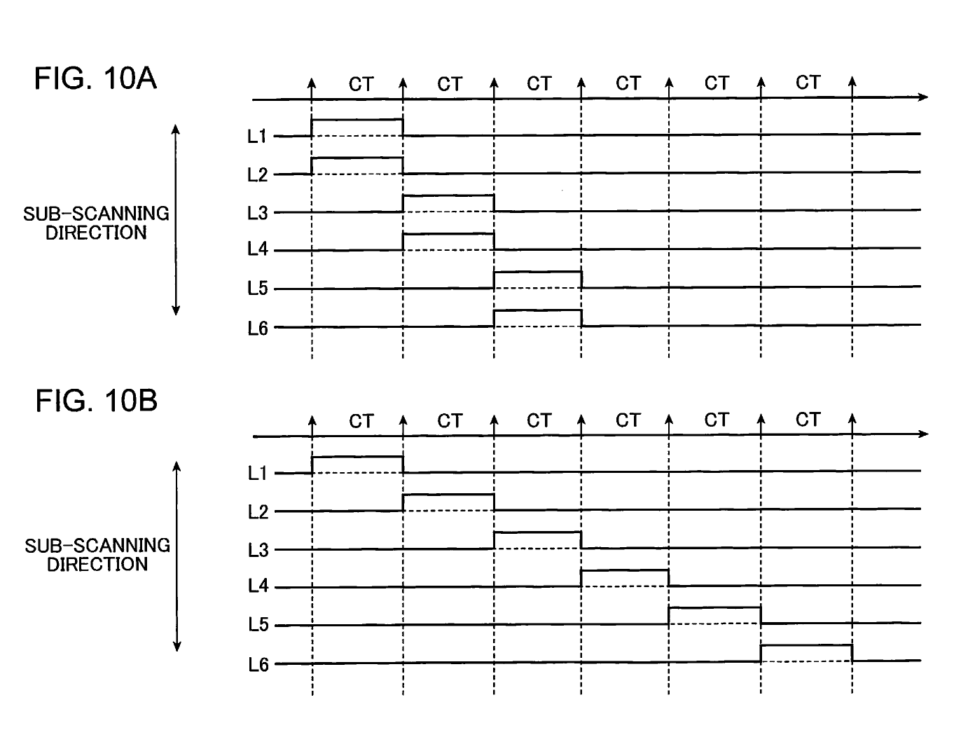

FIGS. 9A to 10B are schematic graphs showing the first and second scanning operations used for the present embodiment. FIG. 9A is a schematic graph showing the first scanning operation. FIG. 9B is a schematic graph showing the second scanning operation. FIG. 10A is a schematic graph showing the writing of the common line signals in the first scanning operation. FIG. 10B is a schematic graph showing the writing of the line signals in the second scanning operation. The first and second scanning operations are described with reference to FIGS. 6 to 10B.

The abscissa of the graphs in FIGS. 9A and 9B is the time axis. The ordinate of the graphs in FIGS. 9A and 9B shows positions in the liquid crystal panels 231 in the sub-scanning direction. The arrows CT shown in the graphs in FIGS. 9A and 9B indicate a time of applied voltage to each pixel along each scanning line aligned in the sub-scanning direction of the liquid crystal panel 231. To make the descriptions easily understood, the frame image having a single color is displayed on the liquid crystal panel 231 by the scanning operations shown in FIGS. 9A and 9B. Therefore, a length of the voltage applying time (i.e., the length of the arrow CT) for each pixel of the liquid crystal panel 231 is constant in the first scanning period. Likewise, the length of the voltage applying time (i.e., the length of the arrow CT) for each pixel of the liquid crystal panel 231 is constant in the second scanning period.

FIGS. 10A and 10B show the scanning lines L1 to L6 aligned in the sub-scanning direction. The chart line along each of the scanning lines L1 to L6 indicates a signal which is input to each scanning line (the chart line in FIG. 10A indicates the common line signal in the first scanning operation while the chart line in FIG. 10B indicates the line signal of the frame image signal that is an L or R signal in the second scanning operation). FIGS. 10A and 10B show six scanning lines, but the descriptions with reference to FIGS. 10A and 10B are similarly applicable to scanning lines below the scanning line L6.

As described with reference to FIGS. 7 and 8, the output portion 260 generates the common line signal in response to the line signals, and outputs the first frame image signal generated in response to the common line signal to the liquid crystal driver 220. The liquid crystal driver 220, which executes the first scanning operation, simultaneously writes the common line signal to each set of scanning lines.

After the output of the first frame image signal, the output portion 260 outputs the second frame image signal to the liquid crystal driver 220. The second frame image signal includes the same image information as the previous frame image signal before the conversion into the first frame image signal.

The liquid crystal driver 220 then executes the first scanning operation with the first frame image signal, and then executes the second scanning operation with the second frame image signal. As mentioned above, the averaging or selecting process is performed for each set which includes a pair of the scanning lines. Therefore, the liquid crystal driver 220 executes the first scanning operation so as to render the frame image, which has half the resolution of that of the second scanning operation. If the averaging or selecting process is performed for each set which includes three or more scanning lines, the resolution of the frame image rendered in the first scanning operation becomes ⅓ or less as high as that of the second scanning operation.

As shown in FIGS. 9A and 10A, the liquid crystal driver 220, which executes the first scanning operation, simultaneously writes the common line signal to a set of the scanning lines corresponding to each display area in response to the first frame image signal. For example, a common line signal generated from line signals, which correspond to the scanning lines L1, L2, respectively, is simultaneously written to the set of the scanning lines L1, L2. After writing the common line signal to the scanning lines L1, L2 in the main scanning direction, the common line signal is written to a set of the scanning lines L3, L4. Since the common line signal is simultaneously written to the scanning lines, the first scanning operation completes in a relatively short time.

As shown in FIGS. 9B and 10B, the liquid crystal driver 220, which executes the second scanning operation, sequentially writes a corresponding line signal to each scanning line in response to the second frame image signal. For example, the line signal of the frame image signal corresponding to the scanning line L1 is written to the scanning line L1. Then, a line signal of the frame image signal corresponding to the scanning line L2 is written to the scanning line L2. Such sequential writing operation is executed over the entire sub-scanning interval S of the liquid crystal panel 231 (c.f., FIG. 2), so that the frame image is displayed on the liquid crystal panel 231.

A time to write the signal to each scanning line (the length of the arrow CT in FIGS. 9A and 9B) is consistent between the first and second scanning operations as shown in FIGS. 9A to 10B. Therefore, in comparison with the first embodiment, the response of the liquid crystals sufficiently progresses by the first scanning operation.

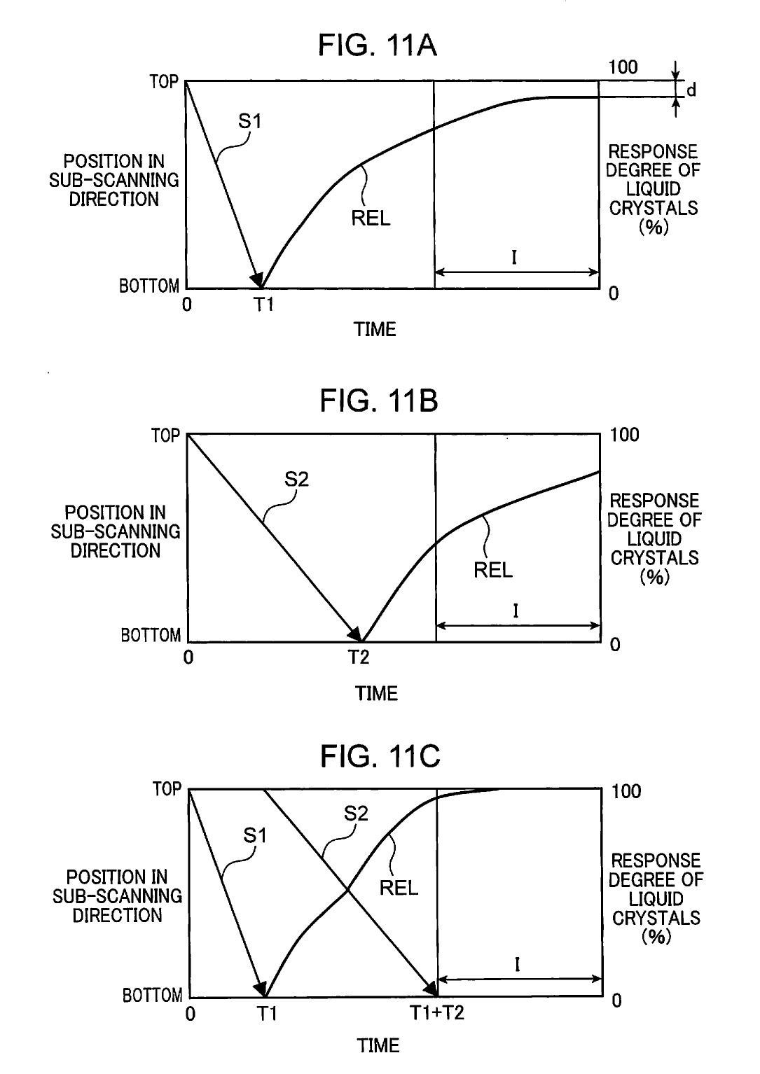

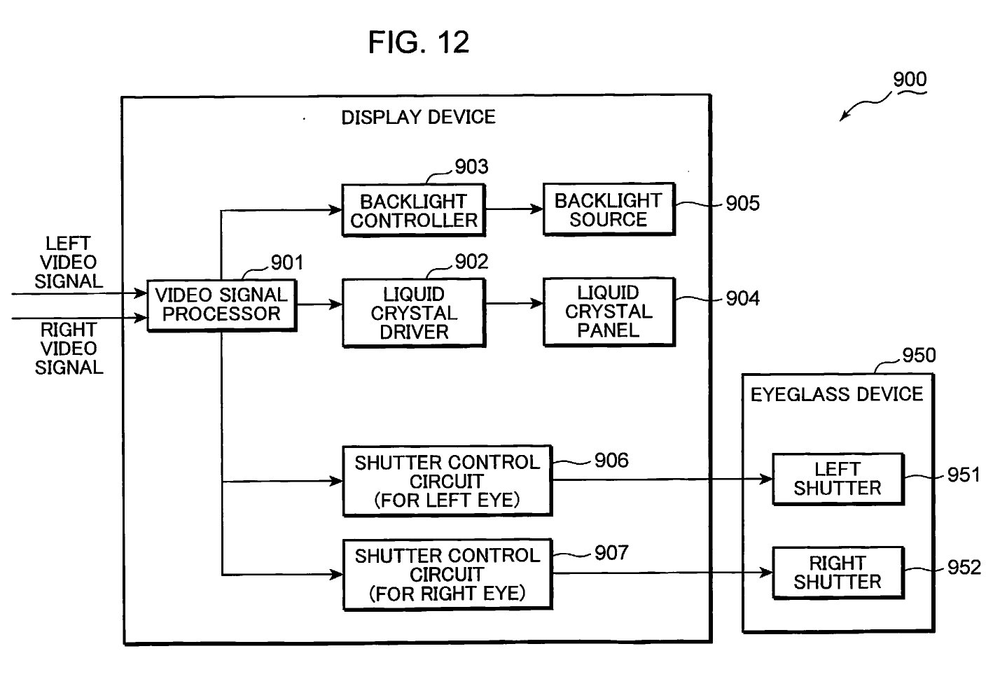

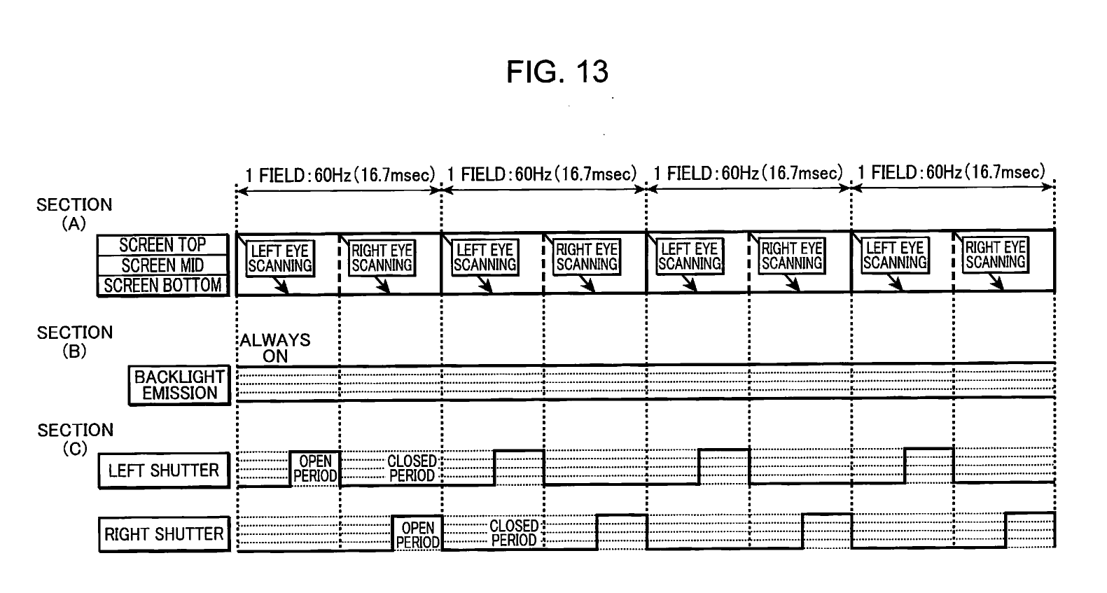

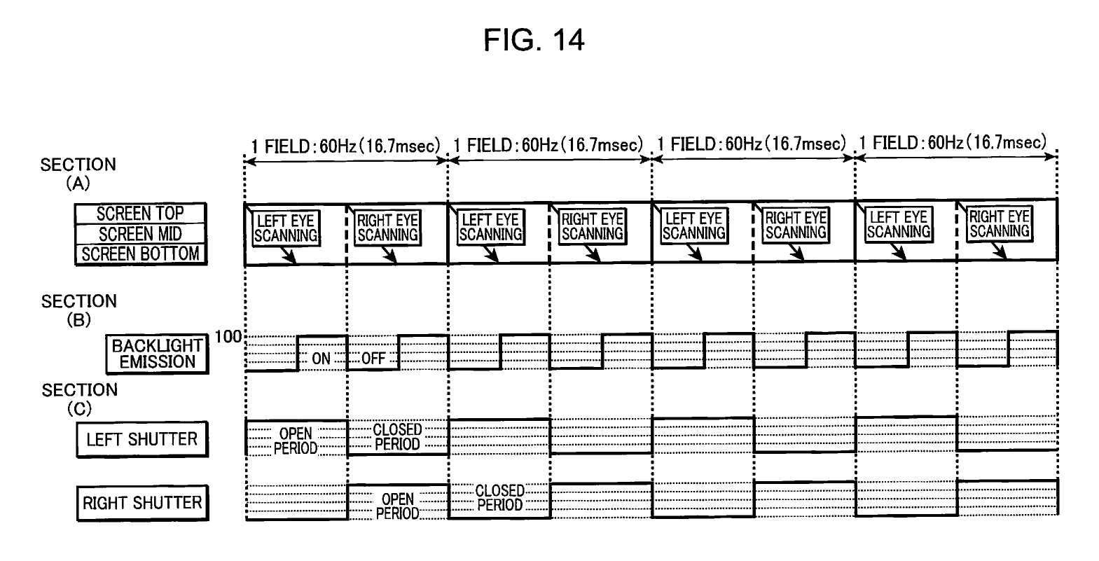

FIGS. 11A to 11C are schematic graphs showing effects from the execution of the first and second scanning operations for displaying one frame image. FIG. 11A shows response of the liquid crystals when only the first scanning operation is executed for one frame image. FIG. 11B shows response of the liquid crystals when only the second scanning operation is executed for one frame image. FIG. 11C shows response of the liquid crystals when the first and second scanning operations are executed for one frame image. The effects of the first scanning operation are described with reference to FIGS. 6 to 11C.

The abscissa of the graphs in FIGS. 11A to 11C is the time axis. The ordinate of the graphs in FIGS. 11A to 11C indicates positions in the liquid crystal panels 231 in the sub-scanning direction. The arrow S1 shown in FIGS. 11A to 11C indicates the first scanning operation. The arrow S2 shown in FIGS. 11A to 11C indicates the second scanning operation.

In the scanning operation shown in FIG. 11A, the common line signal generated by the aforementioned averaging or selecting process is written to the lowermost scanning line in the liquid crystal panel 231 from the time “0”. The liquid crystal driver 220 sequentially writes the common line signals to lower scanning lines. At the time “T1”, it is completed to write the line signal to the lowermost scanning line in the liquid crystal panel 231.

In the scanning operation shown in FIG. 11B, the line signal is written to the uppermost scanning line in the liquid crystal panel 231 from the time “0”. The liquid crystal driver 220 sequentially writes the line signals to the lower scanning lines. At the time “T2”, it is completed to write the line signal to the lowermost scanning line in the liquid crystal panel 231.

In the first scanning operation shown in FIG. 11C, the common line signal is written to the uppermost scanning line in the liquid crystal panel 231 from the time “0”. The liquid crystal driver 220 sequentially writes the common line signals to the lower scanning lines. At the time “T1”, it is completed to write the line signal to the lowermost scanning line in the liquid crystal panel 231.

The liquid crystal driver 220 then executes the second scanning operation. From the time “T1”, the line signal is written to the uppermost scanning line in the liquid crystal panel 231. After that, the liquid crystal driver 220 sequentially writes line signals to lower scanning lines. At the time “T1+T2”, it is completed to write the line signal to the lowermost scanning line in the liquid crystal panel 231.

The right ordinate of the graphs in FIGS. 11A to 11C shows a degree of response of the liquid crystals driven by the line signal written to the lowermost scanning line in the liquid crystal panel 231. The chart lines REL shown in FIGS. 11A to 11C indicate a degree of response of the lowest liquid crystals in the liquid crystal panel 231.

The value “100” on the right ordinate of the graphs in FIGS. 11A to 11C means a degree of response of liquid crystals which allows transmission of light from the backlight source 232, so that the transmitted light amount becomes equivalent to a light amount required for displaying a color defined by the line signal written to the lowermost scanning line in the liquid crystal panel 231. The value “0” indicates a degree of response of the liquid crystals in response to the previous frame image signal.

The resolution of an image rendered by the common line signal written to the first scanning operation is lower than the resolution of the image defined by the L or R signal, which is output from the video signal processor 210. As a result, if only the first scanning operation is executed, the response degree of the liquid crystals becomes different from the degree of response, which corresponds to the original image defined by the L or R signal output from the video signal processor 210. In the graph shown in FIG. 11A, the difference in the response degree of the liquid crystals is indicated by the symbol “d”.

The writing method with only the second scanning operation shown in FIG. 11B is the same as that described with reference to FIG. 5B. If only the second scanning operation is executed to display the frame image, the liquid crystals along the lowermost scanning line starts response at the time “T2”, which is relatively late. As a result, the liquid crystals along the lowermost scanning line do not reach a sufficient degree of response at the beginning of the light volume-up period I.

If the liquid crystal driver 220 executes the first scanning operation as shown in FIG. 11C, the liquid crystals along the lowermost scanning line start response at the time “T1”. If the liquid crystal driver 220 then executes the second scanning operation from the time “T1”, the liquid crystals after the response by a predetermined amount due to the first scanning operation further respond to reach the target response degree by the second scanning operation. As a result, the liquid crystals along the lowermost scanning line may reach a desired degree of response (degree of response with which the resolution of the original image may be achieved) in a relatively short time.

As shown in FIG. 11C, if the light volume-up period I is started at the time “T1+T2”, the liquid crystals driven by the first and second scanning operations reach a degree of response which is close to or matches with the target degree of response required for the original image. As mentioned above, the liquid crystals driven only by the first scanning operation have a degree of response distant from the target value due to the difference between a response degree of a displayed image and a required response degree for the original image. The liquid crystals driven only by the second scanning operation have a low degree of response because of the delay in the response start. On the other hand, if the liquid crystal driver 220 executes the first and second scanning operations, crosstalk is preferably decreased even in a portion of a frame image displayed in the display area of the liquid crystal panel 231 by the scanning operation at a relatively late timing. Thus, the viewer may view the frame image with less crosstalk.

As shown in FIGS. 9A to 11C, the length “T1” of the first scanning period becomes half the length “T2” of the second scanning period by simultaneously writing the common line signal to a pair of the scanning lines. As mentioned above, the common line signal may be generated from the line signals corresponding to three or more adjacent scanning lines. In this case, each display area is defined by pixel rows arrayed along the three or more adjacent scanning lines. The common line signal generated from the line signals corresponding to the three or more adjacent scanning lines is simultaneously written to the scanning lines in each display area. As a result, the length “T1” of the first scanning period is decreased to ⅓ of the length “T2” of the second scanning period or less. A number of scanning lines included in a set of the scanning lines, on which the averaging or selecting process is performed, is set to an appropriate value with taking account of the time when the liquid crystals start response, and a value of difference “d” between the response degree of the liquid crystals implemented in the first scanning operation and the response degree of the liquid crystals required for the original image. Because of the decreased length “T1” of the first scanning period, the period for executing the second scanning operation after the first scanning operation and before the left or right filter 311, 312 increases the light amount may be appropriately secured.

In the second embodiment as well, the liquid crystals in lower portions of the liquid crystal panel 231 respond relatively early by the first scanning operation, like the response of the liquid crystals described with reference to FIGS. 4 to 5C. Therefore the liquid crystals of the liquid crystal panel 231 evenly respond over the entire sub-scanning interval S of the liquid crystal panel 231 before the start of the light volume-up period I. Thus, a local increase in crosstalk in lower portions of the liquid crystal panel 231 may be appropriately controlled.

The aforementioned embodiments primarily have the following configurations. The display device and the video viewing system may control crosstalk between the left and right frame images.

A display device according to one aspect of the aforementioned embodiments includes: a liquid crystal panel configured to switch between a left frame image, which is viewed by a left eye, and a right frame image, which is viewed by a right eye, to alternately display the left and right frame images on a display surface with time; and a liquid crystal driver which scans and drives the liquid crystal panel with a frame image signal to display the left or right frame image over the display surface, wherein the liquid crystal driver executes a first scanning operation over the display surface and a second scanning operation over the display surface after the first scanning operation, the first scanning operation is executed in a shorter period than the second scanning operation.

According to the aforementioned configuration, the liquid crystal panel switches between the left and right frame images which are viewed by the left and right eyes, respectively, to alternately display the left and right frame images on the display surface with time. The liquid crystal driver scans and drives the liquid crystal with the frame image signal to display the left or right frame image over the display surface. The liquid crystal driver executes the first scanning operation over the display surface and the second scanning operation over the display surface after the first scanning operation. The first scanning operation is executed in a shorter period than the second scanning operation. Since it started at an early timing to drive the liquid crystals over the entire liquid crystal panel due to the first scanning operation, there may be little delay of time when liquid crystals complete responses over the frame image. Thus, local crosstalk in the frame image may be preferably decreased. The first scanning operation is executed in a shorter period than the second scanning operation, so that an appropriate period to execute the second scanning operation may be secured.

In the aforementioned configuration, it is preferable that the first scanning operation is executed at a higher writing frequency of the frame image signal by the liquid crystal driver than the second scanning operation.

According to the above configuration, the first scanning operation is executed at a higher writing frequency of the frame image signal by liquid crystal driver than the second scanning operation. Thus, the first scanning operation is executed in a shorter period than the second scanning operation to secure an appropriate period for the second scanning operation.

In the aforementioned configuration, it is preferable that the display device further includes an output portion configured to output the frame image signal to the liquid crystal driver, wherein the frame image signal output from the output portion includes a first frame image signal which is used for the first scanning operation and a second frame image signal which is used for the second scanning operation, and the liquid crystal driver executes the first scanning operation with the first frame image signal to achieve a lower resolution than the second scanning operation with the second frame image signal.

According to the above configuration, the output portion outputs the first and second frame image signals which are used for the first and second scanning operations, respectively. The liquid crystal driver executes the first scanning operation with the first frame image signal to achieve a lower resolution than the second scanning operation with the second frame image signal. Thus, the first scanning operation is executed in a shorter period than the second scanning operation to secure an appropriate period for the second scanning operation.

In the above configuration, it is preferable that the frame image signal has line signals defined by horizontal synchronization signals, the liquid crystal panel has scanning lines to which the line signals are written, respectively, the output portion outputs a common line signal which is simultaneously written to the scanning lines in the first scanning operation in response to the line signals, and the liquid crystal driver simultaneously writes the common line signal to the scanning lines during the first scanning operation, and sequentially writes the line signals to the scanning lines, respectively, during the second scanning operation.

According to the above configuration, the frame image signal has the line signals defined by the horizontal synchronization signal. The liquid crystal panel includes the scanning lines to which the line signals are written, respectively. The output portion outputs the common line signal which is simultaneously written to the scanning lines in the first scanning operation in response to the line signals. The output portion uses the common line signal to output the first frame image. The output portion also uses the line signals to output the second frame image. The liquid crystal driver simultaneously writes the common line signal to the scanning lines during the first scanning operation. The liquid crystal driver sequentially writes the line signals to the scanning lines, respectively, during the second scanning operation. Thus, the first scanning operation is performed in a shorter time than the second scanning operation to secure a period for the second scanning operation.

In the above configuration, it is preferable that the frame image has a first image portion and a second image portion which are displayed on the liquid crystal panel, the line signals include first line signals to display the first image portion and second line signals to display the second image portion, the scanning lines include first scanning lines to which the first line signals are written, and second scanning lines to which the second line signals are written, the common line signal includes a first common line signal which is generated in response to the first line signals and a second common line signal which is generated in response to the second line signals, and the liquid crystal driver simultaneously writes the first common line signal to the first scanning lines and the second common line signal to the second scanning lines during the first scanning operation, and sequentially writes the first line signals to the first scanning lines and the second line signals to the second scanning lines during the second scanning operation.

According to the above configuration, the frame image has the first and second image portions which are displayed on the liquid crystal panel. The first line signals are used to render the first image portion. The second line signals are used to render the second image portion. The first line signals are written to the first scanning lines. The second line signals the written to the second scanning lines. The common line signal has the first common line signal, which is generated in response to the first line signals, and the second common line signal, which is generated in response to the second line signals. The liquid crystal driver simultaneously writes the first and second common line signals to the first and second scanning lines, respectively, during the first scanning operation. The liquid crystal driver sequentially writes the first and second line signals to the first and second scanning lines, respectively, during the second scanning operation. Thus, the first scanning operation is performed in a shorter time than the second scanning operation to secure a period for the second scanning operation.

In the above configuration, it is preferable that the output portion outputs the first common line signal generated by averaging the first line signals, and the second common line signal generated by averaging the second line signals.

According to the above configuration, the output portion outputs the first common line signal generated by averaging the first line signals, and the second common line signal generated by averaging the second line signals. As a result, the liquid crystal driver performs the first scanning operation with the first frame image signal to achieve a lower resolution than the second scanning operation performed by the liquid crystal driver using the second frame image signal. Thus, the first scanning operation is performed in a shorter time than the second scanning operation to secure a period for executing the second scanning operation.

In the aforementioned configuration, it is preferable that the output portion selects one of the first line signals to output the selected first line signal as the first common line signal, and selects one of the second line signals to output the selected second line signal as the second common line signal.

According to the above configuration, the output portion selects one of the first line signals to output the selected first line signal as the first common line signal. The output portion also selects one of the second line signals to output the selected second line signal as the second common line signal. The liquid crystal driver then performs the first scanning operation with the first frame image signal to achieve a lower resolution than the second scanning operation performed by the liquid crystal driver with the second frame image signal. Therefore, the first scanning operation is performed in a shorter time than the second scanning operation to secure a period for executing the second scanning operation.

It is preferable that the display device further includes: a controller configured to control an eyeglass device including a left filter, which adjusts a light amount reaching the left eye, and a right filter, which adjusts a light amount reaching the right eye, wherein the controller controls the left filter to increase the light amount reaching the left eye so that the left frame image is viewed by the left eye, and the right filter to increase the light amount reaching the right eye so that the right frame image is viewed by the right eye, the liquid crystal driver executes the second scanning operation to display the left frame image before the controller controls the left filter to increase the light amount reaching the left eye, and the liquid crystal driver executes the second scanning operation to display the right frame image before the controller controls the right filter to increase the light amount reaching the right eye.

According to the above configuration, the controller controls the left filter to increase the light amount reaching the left eye, so that the left frame image is viewed by the left eye. The controller also controls the right filter to increase the light amount reaching the right eye, so that the right frame image is viewed by the right eye. The liquid crystal driver executes the second scanning operation to display the left frame image before the controller controls the left filter to increase the light amount which reaches the left eye. The liquid crystal driver also executes the second scanning operation to display the right frame image before the controller controls the right filter to increase the light amount which reaches the right eye. Thus, the viewer may preferably view the left and right frame images which the liquid crystal panel switches to each other to alternately display them with time.

A video viewing system according to another aspect of the above embodiments has: a display device configured to display a left frame image, which is viewed by a left eye, and a right frame image, which is viewed by a right eye; and an eyeglass device including a left filter, which adjusts a light amount reaching the left eye so that the left frame image is viewed, and a right filter, which adjusts a light amount reaching the right eye so that the right frame image is viewed, wherein the display device has: a liquid crystal panel configured to switch between the left and right frame images to alternately display the left and right images on a display surface with time; and a liquid crystal driver which scans and drives the liquid crystal panel with a frame image signal to display the left or right frame image over the display surface, wherein the liquid crystal driver executes a first scanning operation over the display surface, and a second scanning operation over the display surface after the first scanning operation, the first scanning operation is executed in a shorter period than the second scanning operation, and the first scanning operation is executed at a higher writing frequency of the frame image signal by the liquid crystal driver than the second scanning operation.

According to the aforementioned configuration, the display device displays the left frame image, which is viewed by the left eye, and the right frame image, which is viewed by the right eye. The left filter of the eyeglass device adjusts the light amount which reaches the left eye, so that the left frame image may be viewed. The right filter of the eyeglass device adjusts the light amount which reaches the right eye, so that the right frame image may be viewed. The liquid crystal panel switches between the left and right frame images to alternately display them on the display surface with time. The liquid crystal driver scans and drives the liquid crystal panel with the frame image signal to display the left or right frame image over the display surface. The liquid crystal driver executes the first scanning operation over the display surface and the second scanning operation over the display surface after the first scanning operation. The first scanning operation is executed in a shorter period than the second scanning operation. Since it started at an early timing to drive the liquid crystals over the entire liquid crystal panel due to the first scanning operation, there may be little delay of time when liquid crystals complete responses over the frame image. Thus, local crosstalk in the frame image may be preferably decreased. The first scanning operation is executed in a shorter period than the second scanning operation, so that a period to execute the second scanning operation may be appropriately secured.

### INDUSTRIAL APPLICABILITY

The principles of the aforementioned embodiments are preferable for a display device and a video viewing system to achieve decreased crosstalk.

1. A display device comprising:
a liquid crystal panel configured to switch between a left frame image, which is viewed by a left eye, and a right frame image, which is viewed by a right eye, to alternately display the left and right frame images on a display surface with time; and
a liquid crystal driver which scans and drives the liquid crystal panel with a frame image signal to display the left or right frame image over the display surface, wherein
the liquid crystal driver executes a first scanning operation over the display surface and a second scanning operation over the display surface after the first scanning operation,
the first scanning operation is executed in a shorter period than the second scanning operation, and
the first scanning operation is executed at a higher writing frequency of the frame image signal by the liquid crystal driver than the second scanning operation.

2. The display device according to claim 1, further comprising:
an output portion configured to output the frame image signal to the liquid crystal driver, wherein
the frame image signal output from the output portion includes a first frame image signal which is used for the first scanning operation and a second frame image signal which is used for the second scanning operation, and
the liquid crystal driver executes the first scanning operation with the first frame image signal to achieve a lower resolution than the second scanning operation with the second frame image signal.

3. The display device according to claim 2, wherein
the frame image signal includes line signals defined by horizontal synchronization signals,
the liquid crystal panel includes scanning lines to which the line signals are written, respectively,
the output portion outputs a common line signal which is simultaneously written to the scanning lines in the first scanning operation in response to the line signals, and
the liquid crystal driver simultaneously writes the common line signal to the scanning lines during the first scanning operation, and sequentially writes the line signals to the scanning lines, respectively, during the second scanning operation.

4. The display device according to claim 3, wherein
the frame image includes a first image portion and a second image portion which are displayed on the liquid crystal panel,
the line signals includes first line signals to display the first image portion and second line signals to display the second image portion,
the scanning lines includes first scanning lines to which the first line signals are written, and second scanning lines to which the second line signals are written,
the common line signal includes a first common line signal which is generated in response to the first line signals and a second common line signal which is generated in response to the second line signals, and
the liquid crystal driver simultaneously writes the first common line signal to the first scanning lines and the second common line signal to the second scanning lines during the first scanning operation, and sequentially writes the first line signals to the first scanning lines and the second line signals to the second scanning lines during the second scanning operation.

5. The display device according to claim 4, wherein
the output portion outputs the first common line signal generated by averaging the first line signals, and the second common line signal generated by averaging the second line signals.

6. The display device according to claim 4, wherein
the output portion selects one of the first line signals to output the selected first line signal as the first common line signal, and selects one of the second line signals to output the selected second line signal as the second common line signal.

7. The display device according to claim 1, further comprising:
a controller configured to control an eyeglass device including a left filter, which adjusts a light amount reaching the left eye, and a right filter, which adjusts a light amount reaching the right eye, wherein
the controller controls the left filter to increase the light amount reaching the left eye so that the left frame image is viewed by the left eye, and the right filter to increase the light amount reaching the right eye so that the right frame image is viewed by the right eye,
the liquid crystal driver executes the second scanning operation to display the left frame image before the controller controls the left filter to increase the light amount reaching the left eye, and
the liquid crystal driver executes the second scanning operation to display the right frame image before the controller controls the right filter to increase the light amount reaching the right eye.

8. A video viewing system comprising:
a display device configured to display a left frame image, which is viewed by a left eye, and a right frame image, which is viewed by a right eye; and
an eyeglass device including a left filter, which adjusts a light amount reaching the left eye so that the left frame image is viewed, and a right filter, which adjusts a light amount reaching the right eye so that the right frame image is viewed, wherein
the display device includes:
a liquid crystal panel configured to switch between the left and right frame images to alternately display the left and right images on a display surface with time; and
a liquid crystal driver which scans and drives the liquid crystal panel with a frame image signal to display the left or right frame image over the display surface, wherein
the liquid crystal driver executes a first scanning operation over the display surface, and a second scanning operation over the display surface after the first scanning operation,
the first scanning operation is executed in a shorter period than the second scanning operation, and
the first scanning operation is executed at a higher writing frequency of the frame image signal by the liquid crystal driver than the second scanning operation.
